(19) United States
(12) Patent Application Publication
(10) Pub. No.: US 2004/0185383 A1
(43) Pub. Date: Sep. 23, 2004

(54) Resist pattern forming method and resist pattern forming system

(75) Inventors: Katsuyuki Nakada, Tokyo (JP); Kazuhiro Hattori, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/801,689

(22) Filed: Mar. 17, 2004

(30) Foreign Application Priority Data
Mar. 18, 2003 (JP) 2003-73680

(51) Int. Cl. G03C 5/00

(52) U.S. Cl. 430/313; 430/312

(57) ABSTRACT

There is provided a resist pattern forming method which makes it possible to form fine resist patterns with a high aspect ratio by using a non-chemically amplified resist easy to treat. In the resist pattern forming method, a resist layer is formed on a substrate by applying a non-chemically amplified resist onto the substrate. Then, the resist layer is exposed. Thereafter, the substrate subjected to the exposure is baked at a temperature not lower than 90° C. but not higher than 130° C., and the baked substrate is developed.

### BACKGROUND OF THE INVENTION

1. Field of the Invention

The present invention relates to a resist pattern forming method and a resist pattern forming system for forming a resist pattern on a substrate by using a resist layer formed of a non-chemically amplified resist.

2. Description of the Related Art

With a growing need for miniaturization of conductive patterns of semiconductor devices and tracks of magnetic recording media (e.g. discrete track recording media), resist patterns for use in manufacturing the semiconductor devices and the magnetic recording media are required to be formed as fine resist patterns having a high aspect ratio. In recent years, as disclosed in Japanese Laid-Open Patent Publication (Kokai) No. H11-39728, a chemically amplified resist has come to be used as a suitable material for forming resist patterns meeting the above mentioned requirements.

However, from the study of the above described conventional resist pattern forming method using the chemically amplified resist, the present inventors found out the following problem: In the conventional resist pattern forming method, a photo acid generator contained in the chemically amplified resist is exposed at the time of exposure to generate acid, and at the time of post-exposure baking called PEB (Post Exposure Bake), the generated acid is thermally diffused to cause reaction of a polymer, whereby solubility of the polymer in a developing solution is changed to form a pattern. In this case, the chemically amplified resist is generally unstable in sensitivity and difficult to handle, as described in the above mentioned publication. More specifically, when the chemically amplified resist is used to form a resist pattern, the acid generated by exposure is progressively deactivated e.g. by ammonia contained in the air before PEB is carried out after the exposure. The degree of this deactivation depends on a time period elapsed from exposure to PEB. For this reason, the conventional resist pattern forming method using the chemically amplified resist requires strict management of the time period between exposure and PEB, which makes the very execution of the method itself troublesome and causes an increase in manufacturing costs.

On the other hand, a resist which is not a chemically amplified type (in the present specification, referred to as “a non-chemically amplified resist”) does not have the property of generating acid and changing solubility of a polymer in a developing solution. Therefore, a resist pattern forming method using the non-chemically amplified resist dispenses with post-exposure baking, and hence it is free from the problem which the conventional resist pattern forming method using the chemically amplified resist suffers from. More specifically, in the resist pattern forming method using the non-chemically amplified resist, normally, after development, a rinsing step of washing off a developing solution and molten resist with rinsing liquid is carried out, and then a drying step of drying the rinsing liquid is carried out. This resist pattern forming method, however, suffers from the problem that in forming a fine resist pattern with a high aspect ratio using the non-chemically amplified resist, traces of the resist pattern are destroyed by the surface tension of the rinsing liquid in the drying step.

### SUMMARY OF THE INVENTION

The present invention has been made as a solution to the above described problem, and an object thereof is to provide a resist pattern forming method which makes it possible to form a fine resist pattern with a high aspect ratio by using a non-chemically amplified resist easy to handle, and a resist pattern forming system for carrying out the resist pattern forming method.

To attain the above object, in a first aspect of the present invention, there is provided a resist pattern forming method comprising the steps of forming a resist layer on a substrate by applying a non-chemically amplified resist onto the substrate, exposing the resist layer, baking the substrate subjected to the exposure at a temperature not lower than 90° C. but not higher than 130° C., and developing the baked substrate.

To attain the above object, in a second aspect of the present invention, there is provided a resist pattern forming system comprising a resist layer forming apparatus that forms a resist layer on a substrate by applying a non-chemically amplified resist onto the substrate, an exposure apparatus that exposes the resist layer formed on the substrate, a baking apparatus that bakes the substrate exposed by the exposure apparatus, at a temperature not lower than 90° C. but not higher than 130° C., and a developing apparatus that develops the substrate baked by the baking apparatus.

According to the resist pattern forming method and system, by using a non-chemically amplified resist as a material for forming a resist layer, and baking the resist layer formed of the non-chemically amplified resist, which does not essentially need post-exposure baking, at a baking temperature set to be not lower than 90° C. but not higher than 130° C., it is possible to increase the hardness of the resist layer and hence a resist pattern formed in the resist layer. As a result, even if the surface tension of rinsing liquid acts between traces of the resist pattern adjacent to each other, destruction of the traces can be fully prevented. This makes it possible to reliably form a fine resist pattern with a high aspect ratio using the non-chemically amplified resist easy to handle.

In the resist pattern forming method, it is preferred that the step of baking the substrate includes baking the substrate at a baking temperature not lower than 100° C. but not higher than 120° C., over a baking time period not shorter than 2 minutes but not longer than 60 minutes. Or, it is preferred that the step of baking the substrate includes baking the substrate at a baking temperature not lower than 90° C. but lower than 100° C., over a baking time period not shorter than 10 minutes but not longer than 60 minutes. Or, it is preferred that the step of baking the substrate includes baking the substrate at a baking temperature higher than 120° C. but not higher than 130° C., over a baking time period not shorter than 2 minutes but not longer than 30 minutes.

In the resist pattern forming system, it is preferred that the baking apparatus bakes the substrate at a baking temperature not lower than 100° C. but not higher than 120° C., over a baking time period not shorter than 2 minutes but not longer than 60 minutes. Or, it is preferred that the baking apparatus bakes the substrate at a baking temperature not lower than 90° C. but lower than 100° C., over a baking time period not shorter than 10 minutes but not longer than 60 minutes. Or, it is preferred that the baking apparatus bakes the substrate at a baking temperature higher than 120° C. but not higher than 130° C., over a baking time period not shorter than 2 minutes but not longer than 30 minutes.

With the arrangements of these preferred embodiments, the substrate is baked over a baking time period not shorter than 2 minutes but not longer than 60 minutes when the baking temperature therefor is not lower than 100° C. but not higher than 120° C., over a baking time period not shorter than 10 minutes but not longer than 60 minutes when the baking temperature is not lower than 90° C. but lower than 100° C., or over a baking time period not shorter than 2 minutes but not longer than 30 minutes when the baking temperature is higher than 120° C. but not higher than 130° C. This makes it possible to reliably form a fine resist pattern with a high aspect ratio using the non-chemically amplified resist easy to handle.

It should be noted that the present disclosure relates to the subject matter included in Japanese Patent Application No. 2003-073680 filed on Mar. 18, 2003, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a cross-sectional view showing an essential part of a substrate having a resist layer formed on a surface thereof by a resist pattern forming method according to an embodiment of the present invention;

FIG. 2 is a cross-sectional view showing the essential part of the substrate in a state where the resist layer in FIG. 1 is irradiated with an electron beam;

FIG. 3 is a cross-sectional view showing an essential part of a master disk;

FIG. 4 is a block diagram showing the arrangement of a resist pattern forming system according to the embodiment of the present invention; and

FIG. 5 is a diagram showing results of observations of resist patterns on master disks formed by changing a temperature (baking temperature) and a time period (baking time period) for PEB.

### DESCRIPTION OF THE PREFERRED EMBODIMENTS

The invention will now be described with reference to the accompanying drawings showing a preferred embodiment thereof. First, a case where the resist pattern forming method and system according to the preferred embodiment of the present invention is applied to the manufacturing of a master disk for use in forming concentric micro asperities on the surface of a discrete track recording medium will be described by way of example.

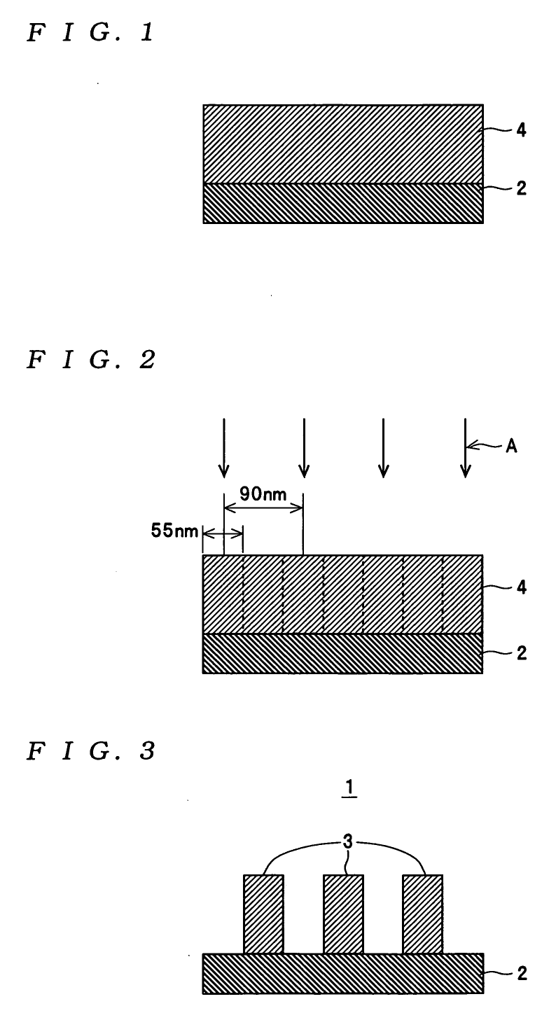

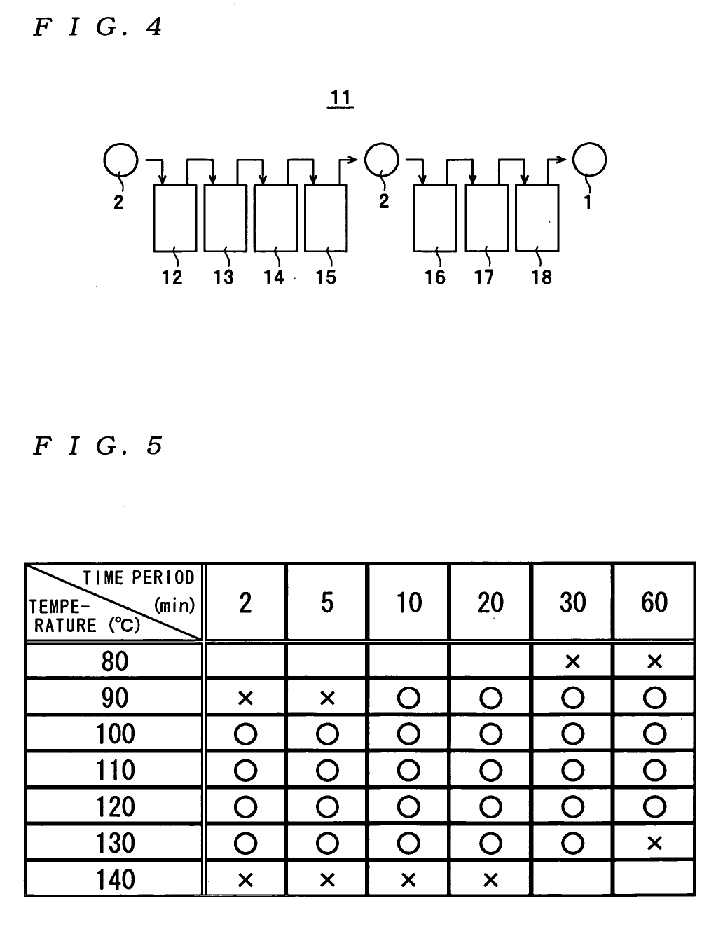

As shown in FIG. 3, the master disk 1 has a substrate 2 formed thereon with numerous traces of a resist pattern 3. It should be noted that in FIGS. 1 to 3, only a part of the substrate 2 is shown with the each thicknesses of the resist pattern 3 and a resist layer 4 exaggerated for purposes of ease of understanding of the present invention. The master disk 1 is manufactured by forming the resist pattern 3 on the surface of the substrate 2 using a resist pattern forming system 11. In the present embodiment, as shown in FIG. 4, the resist pattern forming system 11 is comprised of a resist layer forming apparatus 12, a pre-baking apparatus 13, an exposure apparatus (energy beam drawing apparatus, e.g. electron beam drawing apparatus) 14, a baking apparatus 15, a developing apparatus 16, a rinsing apparatus 17, and a drying apparatus 18.

Next, a description will be given of a process for manufacturing the master disk 1 by forming the resist pattern on the substrate 2 using the resist pattern forming system 11.

In the process for manufacturing the master disk 1, first, a non-chemically amplified positive resist (e.g. ZEP-520 available from Zeon Corporation) is applied onto the surface of the substrate 2 by using the resist layer forming apparatus 12 to thereby form the resist layer 4 having a thickness of 100 nm, for example, on the substrate 2 as shown in FIG. 1 (resist layer forming step). Then, the substrate 2 having the resist layer 4 formed thereon is subjected to heat treatment (pre-baking) using the pre-baking apparatus 13 for five minutes in an atmosphere of 180° C. (pre-baking step). Subsequently, as shown in FIG. 2, a latent image of a predetermined pattern is formed on the resist layer 4 by irradiating the resist layer 4 with an electron beam A by using the exposure apparatus (electron beam drawing apparatus) 14 (exposure step). For example, under irradiation conditions defined such that grooves to be formed after development have a width of 55 nm, the electron beam A is applied onto the resist layer 4 to draw a plurality of concentric circles on the resist layer 4 by progressively increasing the radius of the circle at a pitch of 90 nm.

Then, post-exposure baking (PEB) is carried out on the substrate 2 having the resist layer 4 formed thereon, in the air for 10 minutes using the baking apparatus 15 whose baking temperature is set to be not lower than 90° C. but not higher than 130° C. (110° C. in the present embodiment, for example) (PEB step). Normally, it is not required to carry out PEB on a resist layer 4 formed of a non-chemically amplified resist, but in the present embodiment, PEB is carried out on the resist layer 4 before development to thereby increase the hardness of the resist layer 4. Subsequently, after subjecting the substrate 2 to natural cooling (cooling step), developing treatment is carried out on the resist layer 4 of the substrate 2 using the developing apparatus 16 (developing step). More specifically, the developing apparatus 16 develops the substrate 2 by soaking the same in a developing solution (e.g. ZED-N50 available from Zeon Corporation) of 26° C. for 3 minutes.

Then, the substrate 2 is soaked in rinsing liquid (e.g. ZMD-D available from Zeon Corporation) of 23° C. (room temperature) for 30 seconds using the rinsing apparatus 17 to thereby remove portions of the resist layer 4 melted by the developing solution (rinsing step). As a result, the resist pattern 3 is formed on the substrate 2 as shown in FIG. 3. In the present embodiment, by irradiating the electron beam A in the exposure step described above, a large number of traces of a resist pattern 3 having a pattern width (width of each trace) of 35 nm are formed on the substrate 2 at a pitch of 90 nm. Finally, rinsing liquid attached to the substrate 2 and the resist pattern 3 are removed by drying using the drying apparatus 18 (drying step). Thus, the formation of resist pattern 3 on the surface of the substrate 2 is completed to complete the master disk 1. In the present embodiment, the hardness of the resist layer 4 (traces of the resist pattern 3 formed in the resist layer 4) is increased by carrying out PEB on the resist layer 4, so that the traces of the resist pattern 3 are formed without being destroyed due to the surface tension of the rinsing liquid.

As described above, according to the resist pattern forming method and system of the present invention, it is possible to increase the hardness of the resist layer 4 by subjecting the resist layer 4 to PEB which is not essentially necessary to the resist layer 4 formed of the non-chemically amplified resist. As a result, even if the surface tension of the rinsing liquid acts between adjacent traces of the resist pattern 3 when the rinsing liquid is being dried, destruction of the traces of the resist pattern 3 can be fully prevented. This makes it possible to reliably form the fine resist pattern 3 with a high aspect ratio on the surface of the substrate 3 using the non-chemically amplified resist easy to handle.

It should be noted that the present invention is by no means limited to the above described embodiment, but it can be modified as required. For example, the materials of the resist, the developing solution and/or the rinsing liquid can be changed as needed. More specifically, although in the present embodiment, the non-chemically amplified positive resist is applied onto the substrate 2 to form the resist layer 4, it is possible to use a non-chemically amplified negative resist. Further, although the resist is exposed to an electron beam, a resist of a type which is exposed to ultraviolet rays can also be used. Furthermore, although the case of manufacturing a master disk for a discrete track recording medium as a magnetic recording medium has been described by way of example, the present invention can also be applied to a process for manufacturing a master disk for optical recording media belonging to the CD family, the DVD family, or the like, as well as to a process of forming resist patterns in the manufacturing of semiconductor integrated circuits.

### EXAMPLES

The present invention will now be described in detail based on Examples.

Following the resist pattern forming method described in the above embodiment, a plurality of samples of the master disk 1 were formed while changing the temperature for PEB in steps of 10° C. from 80° C. to 140° C., and setting baking time periods at the respective temperature levels to 2 minutes, 5 minutes, 10 minutes, 20 minutes, 30 minutes, and 60 minutes. In this example, in the resist layer forming step, ZEP-520 (available from Zeon Corporation) as a non-chemically amplified positive resist was used to form a resist layer 4. In the pre-baking step, 5-minute pre-baking was executed in an atmosphere of 180° C. In the exposure step, under the irradiation conditions defined such that grooves formed after development have a width of 55 nm, the electron beam A was applied onto the resist layer 4 at a pitch of 90 nm to form a latent image. In the developing step, the substrate 2 was soaked in a developing solution (ZED-N50 available from Zeon Corporation) of 26° C. for 3 minutes for development. Further, in the rinsing step, the substrate 2 was soaked in a rinsing liquid (ZMD-D available from Zeon Corporation) of 23° C. (room temperature) for approximately 30 seconds, for rinsing. Under the above conditions, a resist pattern 3 defined to have a height of 100 nm and a width of 35 nm and arranged at a pitch of 90 nm was formed on each sample of the master disk 1. Further, other samples of the master disk are formed under the same conditions except the omission of PEB.

Then, whether or not an abnormality, such as destruction, occurred in the resist pattern 3 was checked by observing the samples by a SEM (scanning electron microscope). The results of checking are shown in FIG. 5.

Although not shown, destruction of traces of the resist pattern 3 was observed in each sample of the master disk which had not been subjected to PEB.

On the other hand, in each sample of the master disk 1 which had been subjected to PEB, in which the baking temperature was set to be not lower than 100° C. but not lower than 120° C., it was observed, as shown in FIG. 5, that the resist pattern 3 had been normally formed without being destroyed in any of the cases where the baking time periods of 2 minutes to 60 minutes are employed. It should be noted that in FIG. 5, each set of conditions under which the resist pattern 3 was normally formed is designated by a mark “O”, and each set of conditions under which some abnormality, such as destruction, occurred is designated by a mark “X”. Further, when the baking temperature for PEB was set to 90° C., traces of the resist pattern 3 were destroyed in the cases where the 2-minute baking time period and the 5-minute baking time period were employed, but in each of the cases where the 10-minute to 60-minute baking time periods were employed, the traces of the resist pattern 3 were normally formed without being destroyed. When the baking temperature for PEB was further lowered to 80° C., although samples were made only in the cases where the 30-minute baking time period and the 60-minute baking time period are employed, destruction of trances of the resist pattern 3 was observed in each of the samples. These observations show that when the temperature for heating the resist layer 4 is excessively low and/or when the amount of heat applied to the resist layer 4 is excessively small, the resist layer 4 is not sufficiently hardened, and hence traces of the resist pattern 3 are destroyed due to the surface tension of the rinsing liquid.

On the other hand, when the baking temperature for PEB was raised to 130° C., it was observed that in the cases where the 2-minute to 30-minute baking time periods are employed, the resist pattern 3 was normally formed without being destroyed. However, in the case of the 60-minute baking time period, although the traces of the resist pattern 3 were not destroyed, a phenomenon (hereinafter referred to as “resist degeneration”) that some adjacent traces of resist pattern 3 are connected by a resist was observed. The resist degeneration of the resist pattern 3 also occurred in all of the cases of the baking time periods when the baking temperature for PEB was set to 140° C. From these observations, it is presumed that the resist pattern 3 came to have fluidity due to an excessively high temperature and/or an excessively large amount of heat applied thereto, and traces, whose fluidity is extremely increased, of the resist pattern 3 moved toward adjacent traces of the resist pattern 3 to come into contact with the same, which caused resist degeneration.

Based on the observations described above, it is understood that destruction of traces of the resist pattern 3 and the resist degeneration can be reliably prevented by setting the baking temperature for PEB within a range of 100° C. to 120° C. Further, it is understood that when the baking temperature for PEB is set to 90° C., destruction of traces of the resist pattern 3 and the resist degeneration can be reliably prevented by setting the baking time period to not shorter than 10 minutes but not longer than 60 minutes. Furthermore, it is understood that when the baking temperature for PEB is set to 130° C., destruction of traces of the resist pattern 3 and the resist degeneration can be reliably prevented by setting the baking time period to not shorter than 2 minutes but not longer than 30 minutes. It should be noted that the baking time period could be set to a longer time period than 60 minutes which is the longest in the present embodiment. However, as the baking time period is prolonged, the PEB step has to take a longer time period, which causes an increase in time required for the resist pattern forming process as a whole. Therefore, it is preferred that the baking time period is set within the range (from 2 minutes to 60 minutes) employed in the present embodiment.

What is claimed is:

1. A resist pattern forming method comprising the steps of:
forming a resist layer on a substrate by applying a non-chemically amplified resist onto the substrate;
exposing the resist layer;
baking the substrate subjected to the exposure at a temperature not lower than 90° C. but not higher than 130° C.; and
developing the baked substrate.

2. A resist pattern forming method as claimed in claim 1, wherein said step of baking the substrate includes baking the substrate at a baking temperature not lower than 100° C. but not higher than 120° C., over a baking time period not shorter than 2 minutes but not longer than 60 minutes.

3. A resist pattern forming method as claimed in claim 1, wherein said step of baking the substrate includes baking the substrate at a baking temperature not lower than 90° C. but lower than 100° C., over a baking time period not shorter than 10 minutes but not longer than 60 minutes.

4. A resist pattern forming method as claimed in claim 1, wherein said step of baking the substrate includes baking the substrate at a baking temperature higher than 120° C. but not higher than 130° C., over a baking time period not shorter than 2 minutes but not longer than 30 minutes.

5. A resist pattern forming system comprising:
a resist layer forming apparatus that forms a resist layer on a substrate by applying a non-chemically amplified resist onto the substrate;
an exposure apparatus that exposes the resist layer formed on the substrate;
a baking apparatus that bakes the substrate exposed by said exposure apparatus, at a temperature not lower than 90° C. but not higher than 130° C.; and
a developing apparatus that develops the substrate baked by said baking apparatus.

6. A resist pattern forming system as claimed in claim 5, wherein said baking apparatus bakes the substrate at a baking temperature not lower than 100° C. but not higher than 120° C., over a baking time period not shorter than 2 minutes but not longer than 60 minutes.

7. A resist pattern forming system as claimed in claim 5, wherein said baking apparatus bakes the substrate at a baking temperature not lower than 90° C. but lower than 100° C., over a baking time period not shorter than 10 minutes but not longer than 60 minutes.

8. A resist pattern forming system as claimed in claim 5, wherein said baking apparatus bakes the substrate at a baking temperature higher than 120° C. but not higher than 130° C., over a baking time period not shorter than 2 minutes but not longer than 30 minutes.
